(19) United States
(12) Patent Application Publication
(10) Pub. No.: US 2026/0009900 A1
(43) Pub. Date: Jan. 8, 2026

(54) METHOD AND SYSTEM FOR ULTRASOUND ACQUISITION AND PROCESSING

(71) Applicant: RESOLVE STROKE, PARIS (FR)

(72) Inventor: Vincent HINGOT, PARIS (FR)

(21) Appl. No.: 19/129,537

(22) PCT Filed: Nov. 17, 2023
(86) PCT No.: PCT/EP2023/082298

§ 371 Date: May 13, 2025

(30) Foreign Application Priority Data
Nov. 17, 2022 (FR) 2211945

(51) Int. Cl. G01S 15/89; G01S 7/52

(52) U.S. Cl. CPC G01S 15/8995; G01S 7/52039; G01S 7/52085; G01S 15/8927

(57) ABSTRACT

A method of acquiring and processing ultrasound waves in which the sequential processing includes, for at least one of the elementary data blocks (Bᵢ) of order i, a computer-implemented block processing (TBᵢ) of order i, including, for at least one data sub-block (SBᵢⱼ) of order j, elementary processing including the combination of data of the data sub-block (SBᵢⱼ) of order j so as to generate an elementary image, the block processing (TBᵢ) of order i being implemented during the acquisition of order i+k0 with k0 integer greater than 0, i+k0 being less than or equal to N.

### INVENTION FIELD

The invention concerns ultrasound imaging.

More specifically, it concerns a method for acquiring and processing ultrasound waves for ultrasound imaging.

The method is, for example, one of super-resolution acquisition and processing of ultrasound waves.

The resolution of conventional ultrasound waves acquisition systems is limited by diffraction phenomena. Typically, resolution is of the order of magnitude of the ultrasound wavelength used by the acquisition system.

By super-resolution we mean a resolution higher than the maximum achievable by a conventional ultrasound waves acquisition system. This maximum resolution is equal to the diffraction limit of the acquired ultrasound waves

By super-resolution ultrasound images, we mean images with a resolution finer than the diffraction limit of the ultrasound waves used to acquire the ultrasound waves used to generate the images. Typically, the images generated have a resolution improved by a factor of between 2 and 20 compared with this diffraction limit.

Super-resolution ultrasound imaging is classically based on the injection into the bloodstream of ultrasound contrast agents in the form of millions of gas microbubbles, which are detected, localized and tracked on successive images to generate a reconstructed image of the vessels imaged.

In the literature, the terms Ultrasound Localization Microscopy or ULM and all its variations, e.g. ultrafast ULM or uULM; transcranial ULM or tULM; sensing ULM or sULM; deep ULM or dULM; Super Resolution UltraSound SR-US; Super Resolution Microvascular Imaging or SR-MI; are ultrasound super-resolution processes that share the use of ultrasound contrast agents, a step of detecting signals from these contrast agents, and a step of reconstructing a super-resolved ultrasound image.

### STATE OF THE ART

Generating super-resolution ultrasound images involves repeating an acquisition sequence by an acquisition device using an ultrasound probe to generate successive data blocks. Each data block is generated during an acquisition sequence.

Each acquisition sequence comprises the repetition, a large number of times, of an elementary acquisition sequence. Each elementary acquisition sequence generates a data sub-block. Each data block is therefore made up of a plurality of data sub-blocks.

Each block of data is stored in a buffer memory of an acquisition device and then transferred to an internal memory of a processing device before the next block of data is acquired. As the speed of transfer and writing to the computer's internal memory is limited, this operation can take a plurality of hundred milliseconds to a plurality of seconds in the case of very large 3D data.

Once all the data blocks have been acquired, they are processed block by block by a processing device. This processing begins by loading data from the internal memory into the computer's access memory (RAM). The data is then sent from the RAM memory to the RAM of a Graphics Processing Unit (GPU), where it undergoes the steps of channel formation and elimination of tissue echoes. The data is then transferred back to the computer's RAM memory, where the microbubbles are detected, localized and tracked over time

The method then includes a step to reconstruct a super-resolution image. This step consists in accumulating the tracking results obtained for each block and for the different blocks.

Processing a block of data can take from a plurality of seconds to a plurality of minutes in the case of very large 3D data.

This method has a number of disadvantages. The acquisition of a new data block has to be stopped while the data is being written to the processing device's internal memory, which adds to the idle time in the acquisition process. Furthermore, the results of data processing are only available after all data blocks have been acquired, once data processing has begun. Finally, large amounts of raw data (10 Gb-1000 Gb) have to be retained by the processing device for the duration of the acquisition and for part of the processing, which can lead to RAM saturation. Finally, additional transfer times are introduced during processing, making it particularly time-consuming (>1 h).

One aim of the invention is to limit at least one of the aforementioned disadvantages.

### SUMMARY OF THE INVENTION

To this end, the object of the invention is a method for acquiring and processing ultrasound waves comprising the sequential acquisition of N elementary data blocks of order i, with i=1 to N, and a computer-implemented sequential processing, the elementary data blocks, the order i of each raw elementary data block being the acquisition order number of data block among the N data blocks, the sequential acquisition comprising, for each elementary data block, the acquisition of the data block of order i comprising J implementations of a data sub-block acquisition of order j, for j=1 to J with J greater than 1, the sub-block acquisition comprising, for each transmission/reception configuration of a set of at least one transmission/reception configuration defined by a transmission sub-aperture and a reception sub-aperture of an array of transducers, a set of at least one individual acquisition sequence comprising:
Transmitting an ultrasound beam, through the transmission sub-aperture, into an area of interest on a patient,
Receiving, by the reception sub-aperture, echoes generated by the zone of interest under the effect of the ultrasound beam, so as to generate electrical signals,
Pre-processing comprising digitizing of signals from the electrical signals to generate a elementary data set
   the sequential processing comprising, for at least one of the elementary data blocks of order i, a computer-implemented block processing of order i, comprising, for at least one data sub-block of order j, an elementary processing comprising combining data of the data sub-block of order j so as to generate an elementary image,
   the block processing of order i being implemented during the acquisition of order i+k0 with k0 being an integer greater than 0, i+k0 being less than or equal to N.

Advantageously, J is between 2 and 2000.

Advantageously, N is between 2 and 10000.

Advantageously, block processing of order I comprises, for each of a plurality of order j data sub-blocks of the block of order i, an elementary processing comprising combining data of the data sub-block of order j so as to generate a plurality of elementary images, the enhancement of the order j elementary image using the elementary image of order j and at least one other elementary image generated for another data sub-block.

According to one embodiment, the block processing of order i is implemented during the acquisition of the data block of order i+1.

In one embodiment, the block processing of order i is implemented only during acquisition of the data block of order i+k0.

According to one embodiment, the method comprises, during acquisition of the data block of order i+k0, providing a user, via a user interface, information from data generated during the block processing of order i.

In one embodiment, elementary processing comprises enhancing signals from contrast agents on the elementary image relative to other signals so as to obtain an enhanced elementary image.

Advantageously, block processing of order i, comprises, for each of a plurality data sub-blocks of order j, the elementary processing comprising combining data of the data sub-block of order j, so as to generate a plurality of elementary images, enhancing the elementary image of order j using the elementary image of order j and at least one other elementary image generated for another data sub-block.

According to one embodiment, the elementary processing comprises detecting signals from contrast agents on the elementary image or on an image from the elementary image so as to obtain a set of positions of contrast agents.

According to one embodiment, i-order block processing comprises the tracking of contrast agents on a plurality of elementary images or images derived from elementary images.

Advantageously, the block processing of order i comprises, for each of a plurality of data sub-blocks of order j, an elementary processing comprising the combination data of the data sub-block of order j, so as to generate a plurality of elementary images, the block processing comprising the tracking of contrast agents on a plurality of elementary images or images derived from elementary images so as to obtain sets of positions of contrast agents.

Advantageously, order i block processing includes a step of reconstructing an image representing the sets of positions of contrast agents.

Advantageously, sequentially processing comprises implementing block processing for a plurality of blocks to generate a plurality of images, sequential processing comprising globally reconstruction a global image from a plurality of images generated during the sequential processing.

According to one embodiment, the order i block processing comprises elementary processes implemented for respective data sub-blocks, in parallel.

According to one embodiment, the individual acquisition sequence comprises storing the elementary data set in a first memory, the method comprising transferring the elementary data block of order i to a second memory, implemented, at least in part, prior to block processing.

In one embodiment, the first memory and the second memory are random access memories, the elementary data block being transmitted from the first memory to the second memory without passing through another memory.

The invention also relates to an ultrasound waves acquisition and processing system, configured to implement the method according to the invention.

Advantageously, the acquisition system comprises hardware and software means configured to implement the method according to the invention.

Advantageously, the acquisition and processing system comprises:
an acquisition system comprising the transducer array and configured to implement the acquisition step,
a processing system configured to implement the sequential processing step.

According to one embodiment, the acquisition system comprises the first memory and the processing system is intended to be communicatively connected to the acquisition system, the processing system comprising the second memory.

The invention also relates to a computer program product comprising instructions which lead the system according to the invention to implement the steps of the method according to the invention.

The invention also relates to a computer-readable medium on which the computer program is recorded.

### BRIEF DESCRIPTION OF FIGURES

Further features and advantages of the invention will become apparent from the following detailed description, with reference to the appended figures, which illustrate:

FIG. 1: An individual acquisition sequence,

FIG. 2: an acquisition step of the method according to the invention,

FIG. 3: a data sub-block acquisition step,

FIG. 4: An example of the timing of the acquisition and block processing stages of a data block in the method according to the invention,

FIG. 5: an example of a processing step in the method according to the invention,

FIG. 6: In block form, the hardware elements of an example of a system configured to implement the method according to the invention.

### DESCRIPTION OF THE INVENTION

The invention relates to a method for acquiring and processing ultrasound waves. This method is, for example, intended for super-resolution imaging. This method is advantageously, but not necessarily, a super-resolution imaging process. The invention also relates to the acquisition and processing system configured to implement the method.

Advantageously, the acquisition and processing system comprises hardware and software means configured to implement the process.

This method is advantageously, but not necessarily, implemented after a step of intravenous injection to an individual of a contrast medium comprising individual contrast agents, for example, in the form of gas microbubbles. These contrast agents injected into the body are of the exogenous type.

Alternatively, the method can be carried out without a prior injection step of this type, using endogenous contrast agents such as red blood cells.

The method comprises the acquisition and sequential ultrasound waves processing of N blocks of ultrasound raw data Bᵢ with i=1 to N where N is the number of blocks of ultrasound raw data Bᵢ acquired and processed.

Therefore, i is an integer.

### Acquisition

The method comprises a step of sequential acquisition A of ultrasound raw data blocks Bᵢ.

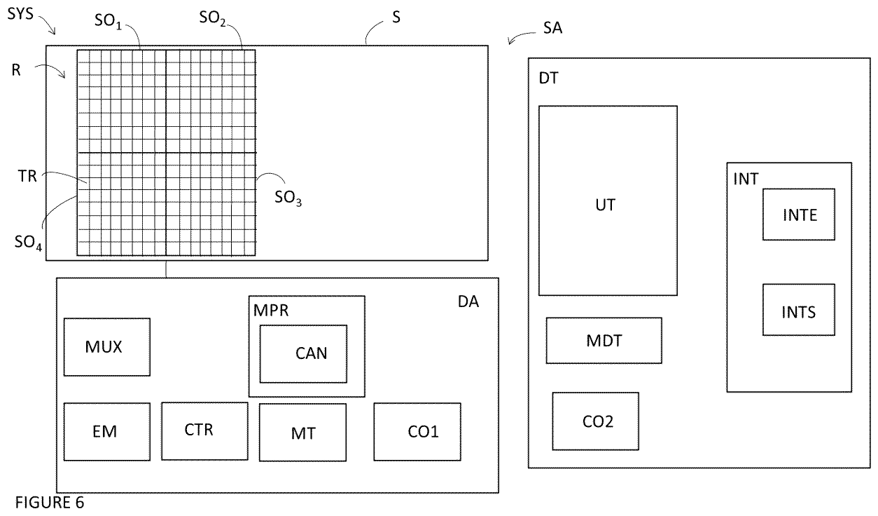

This step is implemented by an acquisition system SA comprising a probe S comprising an array R of transducers TR referenced in FIG. 6. It is possible to define sub-apertures of the array R, each sub-aperture being composed of one or more of the transducers TR of the array R.

Each sub-aperture is made up, for example, of all the transducers TR in the R network.

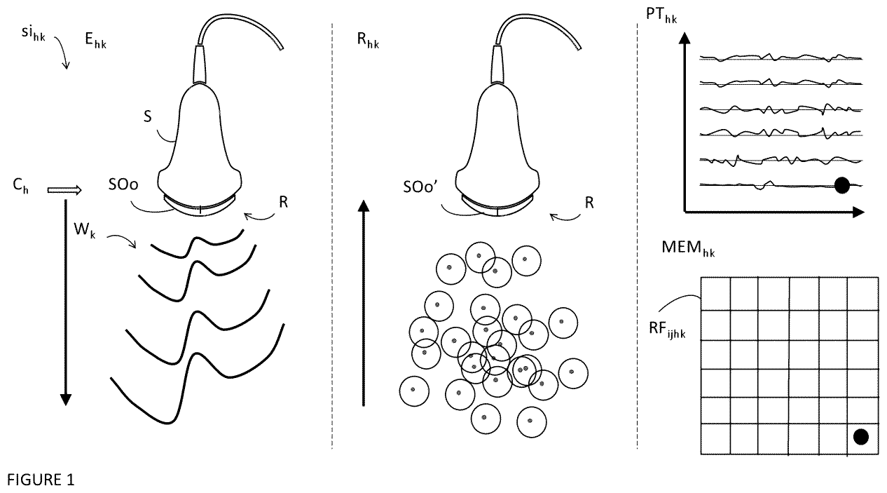

As shown in FIG. 1, a transmission sub-aperture SOo and a receive sub-aperture SOo′ are defined, defining a transmission/reception configuration Cₕ characterized by a pair (SOo, SOo′). The reception sub-aperture SOo may be different from or identical to the transmit sub-aperture SOo. The sub-aperture pairs of different Cₕ configurations are different.

In the non-limiting example shown in FIG. 1, the transmission sub-aperture SOo is the reception sub-aperture SOo′.

The acquisition of an ultrasound data block Bᵢ comprises the repetition, preferably a large number of times, of an individual acquisition sequence siₕₖ comprising the following steps shown in FIG. 1:
Emission Eₕₖ of an ultrasound beam Wₖ through the transmission sub-aperture SOo of the array R of transducers (referenced in FIG. 6),
Reception Rₕₖ of echoes transmitted by the surrounding environment under the effect of the ultrasound beam Wₖ by the reception sub-aperture SOo′ of the array R of transducers TR to generate electrical signals,
Computer-implemented, pre-processing PTₖₕ, by the acquisition system, comprising digitization of the electrical signals to generate an elementary data set RFᵢⱼₕₖ, and possibly (but not necessarily) one or more other operations performed on the received echoes, such as filtering and/or demodulation (carrier suppression) and/or time gain compensation (TGC) and/or resampling of the digitized signals.

Among the transducers TR of the array R, only the transducer(s) of the transmission sub-aperture transmit(s) a signal to generate the ultrasound beam Wₖ transmitted during the emission step Eₕₖ.

The electrical signals processed, in particular digitized, during the pre-processing stage comprise only electrical signals generated by each of the transducer(s) of the reception sub-aperture, during the receiving step Rₕₖ, among the electrical signals generated by the transducers TR of the array R during this receiving step Rₕₖ.

In FIG. 1, the echoes received are represented in the form of a plurality of time signals corresponding to the evolution, over time, of the signal received by each of the transducers in the reception sub-aperture SOo′.

The elementary data set RFᵢⱼₕₖ is shown in form of a table in FIG. 1, and comprises a time sampling of the signal received by each of the transducers in the reception sub-aperture. Each box corresponds to a time sample from one of the transducers in the reception sub-aperture. The box with the black circle corresponds to the time sample marked with a black circle.

Advantageously, the individual acquisition sequence sink comprises a step of storing MEMₕₖ the elementary data set RFᵢⱼₕₖ in a first memory.

Each individual sequence siₕₖ is advantageously designed so that the ultrasound beam transmited during the reception step insonifies the individual's region of interest containing contrast agents, for example, in the form of microbubbles, and so as to receive, during the reception step, echoes from the region of interest. In this way, the raw ultrasound data originates from a patient's region of interest containing contrast agents during the acquisition step.

Alternatively, contrast agents can be endogenous. In vascular ultrasound, for example, red blood cells can be used.

Advantageously, the zone of interest is an area of the patient comprising blood vessels in which endogenous or exogenous contrast agents are present at the time of the acquisition phase.

Advantageously, the circulating contrast agents move relative to the zone of interest.

If the area of interest includes blood vessels, the contrast agents move advantageously in the blood vessels as a result of the blood flow in the vessels.

In the following, we will consider a non-limiting example in which the acquisition concerns an area comprising contrast agents in the form of microbubbles. The steps described below relating to these microbubbles are valid for other types of contrast agents.

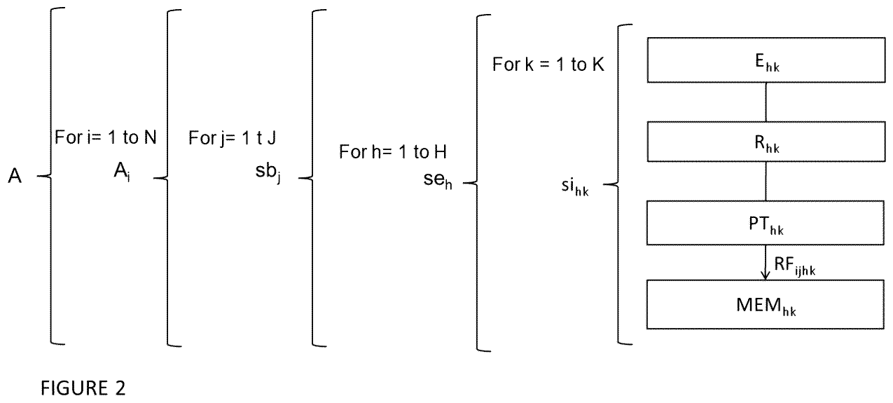

As shown in FIG. 2, acquisition step A comprises an elementary acquisition sequence seₕ, in which K individual acquisition sequences sink, where K is an integer greater than or equal to 1, are implemented using the same transmission/reception configuration Cₕ to acquire K elementary data sets RFᵢⱼₕₖ.

Preferably K is between 1 and 100.

The individual acquisition sequences siₕₖ differ from one another in that the ultrasound beams Wₖ have distinct spatial and/or temporal (frequency) characteristics. For example, in one embodiment, the K ultrasound beams may be a family of plane waves emitted at different angles to the R grating. In another embodiment, K beams corresponding to waves with respective amplitudes differing from one another by predetermined scalar factors are sent.

The method comprises an acquisition step sbⱼ of a data sub-block SBᵢⱼ which comprises the implementation of H elementary acquisition step(s) seₕ with h=1 to H, where H is an integer greater than or equal to 1, performed with respective distinct transmission/reception configurations Cₕ.

For example, H is equal to 1, corresponding to a single transmission/reception configuration Cₕ=1.

Preferably H is between 1 and 100.

h is an integer.

The elementary acquisition step Aᵢ of a data block Bᵢ comprises the implementation of the acquisition step sbⱼ of a data sub-block SBᵢⱼ. This step is implemented J times so as to acquire J data sub-blocks SBᵢⱼ. J is an integer greater than or equal to 1. Typically, J is between 1 and 2000. Advantageously, J may be the same for each data block Bᵢ, but some of the data blocks Bᵢ may alternatively have distinct J values.

Preferably, J is greater than or equal to 2 and more preferably greater than or equal to 10, for example greater than or equal to 15 or 20.

Preferably, J is less than or equal to 1000 or 2000.

Advantageously, the product of J*N is greater than or equal to 4.

Advantageously, the product of J*N is between 50000 and 150000.

The resolution of the final image is better when the product is larger.

The data sub-blocks SBᵢⱼ are acquired successively in the temporal order defined by the index j representing the j^{th} implementation of the sub-block acquisition step, noted sbⱼ.

In other words, index j is an integer.

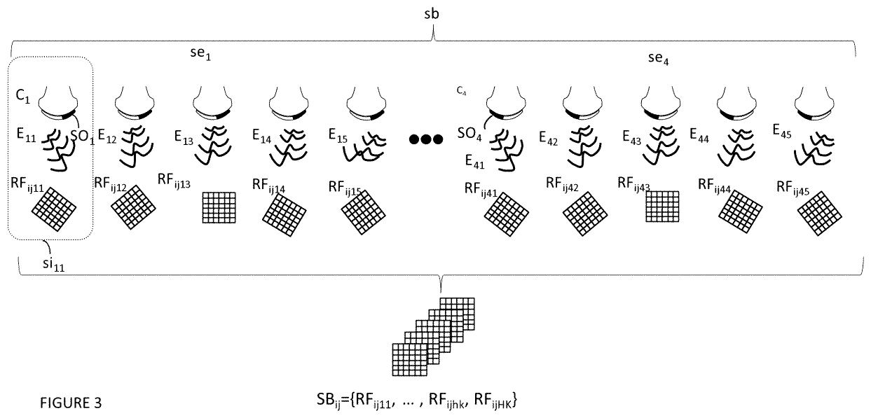

When the acquisition step sbⱼ for acquiring a data sub-block SBᵢⱼ has been implemented, i.e. when the elementary acquisition sequences seₕ have been implemented for the different Cₕ transmission/reception configurations (with h=1 to H), an elementary data sub-block SBᵢⱼ composed of H*K elementary data sets RFᵢⱼₕₖ is obtained, as shown in FIG. 3. The sequential acquisition step A of the N raw data blocks Bᵢ comprises the implementation of the elementary acquisition step Aᵢ to acquire an ultrasound data block Bi of order i. The elementary acquisition step Aᵢ is implemented N successive times so as to acquire the N data blocks Bi. The data blocks Bᵢ are acquired successively in the temporal order defined by the index i representing the i^{th} implementation of the elementary acquisition step Aᵢ.

N is an integer greater than 1. N is advantageously determined so that N*J*H*K is between 1000 and 10,000,000. In a typical embodiment, N=300, J=1000, H=4 and K=5, i.e. N*J*H*K=6,000,000.

Preferably, N is greater than or equal to 2, 10, 15 or 20, and more preferably greater than or equal to 100.

Preferably, N is less than or equal to 1,000 or 10,000.advantageously N greater than J. This limits the size of the memory(s) and generates faster access to images.

Alternatively, N is less than or equal to J.

In order to generate a number equal to N data blocks Bᵢ, the acquisition step Aᵢ of a raw data block Bᵢ is repeated N−1 times. The result is a set B, such that B={B₁, . . . , Bᵢ, . . . , B_{N}} of raw data blocks Bᵢ. The step Aᵢ of index i corresponds to the implementation, for the i^{eme} time, of the step of acquiring Aᵢ of a raw data block and enables the acquisition of the data block Bᵢ of order i.

FIG. 3 shows two transmission/reception configurations C₁ and C₄ of the ultrasound probe S. Configuration C₁ is characterized by a transmission sub-aperture SO₁ which is also the reception sub-aperture of the same configuration C₁. Configuration C₄ is characterized by a transmission sub-aperture SO₄ which is also the reception sub-aperture of this same configuration C₄.

Also shown are the transmission steps Eₕₖ of the individual acquisition sequences si₁ₖ and si₄ₖ (with k=1 to 5) implemented during elementary acquisition sequences se₁ and se₄ using the respective transmission/reception configurations C₁ and C₍₄₎, and the elementary data sets RFᵢⱼₕₖ generated during these elementary acquisition sequences.

In other words, the index k is generally an integer.

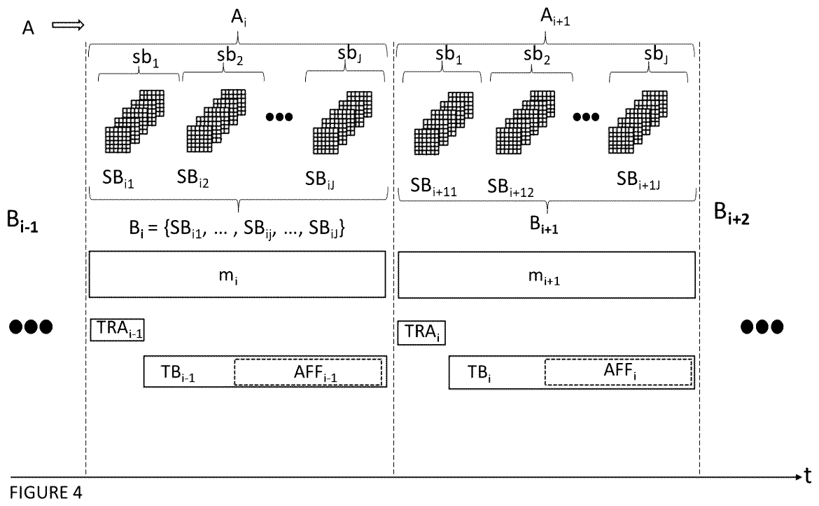

FIG. 4 shows various steps involved in acquiring and processing two consecutively acquired blocks of data, Bᵢ and B₍ᵢ₊₁₎, in the temporal order represented by the t axis.

Each raw data block Bᵢ comprises a number J of data sub-blocks SBᵢⱼ with j=1 to J, where J is an integer greater than or equal to 1, acquired during the respective J implementations of step sbⱼ for acquiring a data sub-block SBᵢⱼ.

As shown in FIG. 4, the data of the raw data block Bᵢ are stored in a storage step mᵢ. This step is advantageously implemented during the acquisition step Aᵢ of the i-th order data block Bᵢ, for the generation of the i-th order data block Bᵢ. In a particular embodiment of the invention, this storage step mᵢ comprises the MEMₕₖ storage steps implemented during the data block Bᵢ acquisition step Ai.

Advantageously, the individual acquisition sequences siₕₖ are performed at a frequency of between 100 Hz and 20,000 Hz.

Advantageously the individual acquisition sequences siₕₖ are performed at a frequency of between 100 Hz and 5000 Hz, for example at 5000 Hz.

High acquisition frequencies mean shorter acquisition times for N data blocks, and better contrast agent monitoring. However, at 5000 Hz or below 500 Hz, patient safety is easier to ensure

### Sequential Processing

The method according to the invention comprises a sequential processing step of the data blocks Bᵢ, implemented by computer, by a processing system, for example, a processing device DT, as we will see in the following text.

The sequential processing step comprises, for at least one data block Bᵢ and preferably for each data block Bᵢ, the implementation, by computer, of a block processing step TBᵢ of order i of the data block Bᵢ, referred to as block processing TBᵢ of the data block of order i or block processing TBᵢ of order i or block processing in the following text.

Generally speaking, the sequential processing step comprises, for at least one data block Bᵢ and preferably for a plurality of data blocks, the block processing TBᵢ of the data block of order i.

Advantageously, but not necessarily, this sequential processing step comprises block processing for each data block of order i, with i=1 to N.

According to the invention, as shown in FIG. 4, the block processing TBᵢ of a data block Bᵢ of order i less than N is implemented during the acquisition step Aᵢ₊ₖ₀ of the data block Bᵢ₊ₖ₀ of order i+k0 with k0 integer greater than or equal to 1, i+k0 being less than or equal to N

In other words, the block processing step TBᵢ of a data block Bᵢ of order i less than N is implemented at least in part during the acquisition step Aᵢ₊ₖ₀ of the data block Bᵢ₊ₖ of order i+k0 with k0 an integer greater than or equal to 1, i+k0 being less than or equal to N.

In the non-limiting example shown in FIG. 4, k0 is equal to 1, so that block processing TBᵢ of data block Bᵢ of order i is implemented during acquisition step Aᵢ₊₁ of data block Bᵢ₊₁. In other words, the block processing step TBᵢ of the data block Bᵢ of order i is implemented during the acquisition Aᵢ₊₁ of the data block Bᵢ₊₁ of order i+1 acquired consecutively to the data block Bᵢ of order i.

The invention therefore involves processing a data block Bᵢ of order i during subsequent acquisition of another data block Bᵢ₊ₖ₀, for example, during acquisition of the next block, i.e. of order i+1. This has the advantage of limiting or even eliminating dead times during acquisition

Furthermore, once the block processing of a data block has been completed, the data resulting from this block processing can be transferred to a display device to provide real-time visual feedback to the user. The method therefore minimizes downtime before displaying data generated from the acquired raw data.

Thus, according to a particular mode of implementation, the block processing step TBᵢ comprises, during the acquisition Aᵢ₊ₖ₀ of the i+k0 order data block Bᵢ₊ₖ₀, displaying AFFᵢ, on a display of an output interface INTS of a man-machine interface INT, referenced in FIG. 6, a representation of information from data generated during the i order block processing TBᵢ.

Finally, the method according to the invention makes it possible, if required, to erase, i.e. delete, the raw data of the Bᵢ raw data blocks as they occur after the respective block processing TBᵢ have been carried out. This further reduces time and memory costs.

When block processing TBᵢ includes a step for locating or tracking microbubble positions on images generated from B₍ᵢ) block data sub-blocks, the data obtained is very small since it consists of successive positions of individual microbubbles. These data can be transferred to an internal memory, i.e. a read-only memory, of the processing system, for example of the processing device, such as a microcomputer, without impacting or slowing down the rest of the process.

Block processing TBᵢ of a data block Bᵢ of order i less than N during acquisition Aᵢ₊ₖ₀ of the data block Bᵢ₊ₖ₀ of order i+k0 with k0 integer greater than or equal to 1, i+k0 being less than or equal to N, can be carried out for one or more data blocks of different orders i, for example for one i, a plurality of i or for any i less than or equal to N−k0. This applies to all the previously described embodiments described below.

Thus, in the case of implementation for any i less than or equal to N−k0, this means that the processing of each data block Bᵢ of order i less than N−k0 is implemented during the acquisition Aᵢ₊ₖ₀ of the data block Bᵢ₊ₖ₀ of order i+k0 with k0 an integer greater than or equal to 1, i+k0 being less than or equal to N. This enhances the advantages of the invention.

Advantageously, for at least one i, block processing TBᵢ of the i-order data block Bᵢ begins during acquisition Aᵢ₊ₖ₀ of the i+k0-order data block Bᵢ₊ₖ₀ and ends during acquisition of the i+l-order data block Bᵢ₊ₗ with l less than or equal to N−i. In this way, processing of the ith-order block is completed before acquisition of the i+lth-order data block. This makes the data generated during block processing available more quickly, and limits memory space to storing data from the acquisition of block i.

In the particular embodiment shown in FIG. 4, k0=1. This minimizes the delay between data acquisition and the start of data processing.

In the particular embodiment shown in FIG. 4, block processing TBᵢ of the ith-order data block Bᵢ begins during acquisition Aᵢ₊₁ of the ith-order data block Bᵢ₊₁ and takes less time than acquisition Aᵢ₊₁ of the ith-order data block Bᵢ₊₁. In other words, block processing TBᵢ of data block Bᵢ of order i is carried out only during acquisition Aᵢ₊₁ of data block Bᵢ₊₁. This minimizes the time it takes to generate the final results of block processing TBᵢ, and therefore the time it takes to display them, or more generally to make them available to a user. This also makes it possible to minimize the latency time between the end of the acquisition of a data block Bᵢ₊₁ of order i+1 and the processing of the data block Bᵢ₊₁ of order i+1, since the processing of the data block of order i has been completed. The display provides the user with a means of feedback on the acquisition, in particular to help maintain stable positioning.

Advantageously, for a plurality of i's or for any i less than or equal to N−k0, the block processing TBᵢ of the i-order data block Bᵢ begins during the acquisition Aᵢ₊ₖ₀ of the i+k0-order data block Bᵢ₊ₖ₀ and ends during the acquisition of the i+k0-order Bᵢ₊ₖ₀ data block. Thus, processing of the i-order data block Bᵢ is completed before acquisition of the i+k0-order data block. One advantage is that the user can be provided with data obtained during the acquisition of the various data blocks. This makes it possible, for example, to reconstruct the final image over time and thus track its evolution during data acquisition Alternatively, for at least one i, for a plurality of i or for any i such that i+k0 is less than or equal to N, the processing of the i-order data block Bᵢ, which begins during the acquisition of the i+k0-order data block Bᵢ₊ₖ₀, ends after the acquisition of the i+k0-order data block Bᵢ₊ₖ₀.

The block processing steps are implemented in the order defined by the order of acquisition of the data blocks of order i or not.

### Block Processing

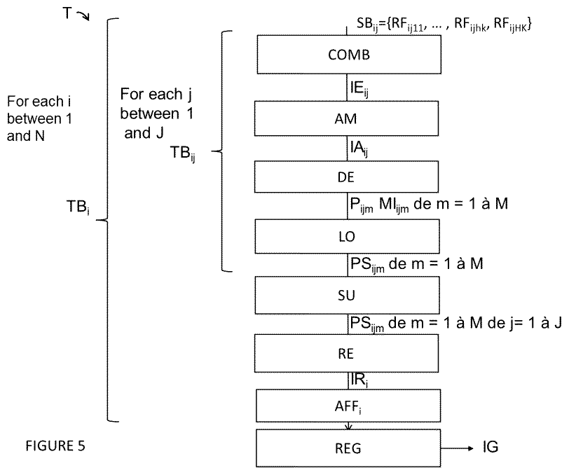

FIG. 5 shows a flowchart of the steps involved in an example of processing T comprising the implementation, for each data block Bᵢ of order i, of a block processing step TBᵢ corresponding to a super-resolution processing step.

The block processing step TBᵢ comprises, for each SBᵢⱼ data sub-block TBᵢⱼ, an elementary processing

Alternatively, order i block processing comprises the implementation of elementary processing TBᵢⱼ for at least one of the data sub-blocks SBᵢⱼ or for a plurality of the sub-blocks SBᵢⱼ taken from the sub-blocks SBᵢⱼ with j=1 to J.

For example, the block processing of order i comprises the implementation of the elementary processing TBᵢⱼ for each of the data sub-blocks of order SBᵢⱼ with j=1 to J. In other words, the block processing of order i comprises J implementations of the elementary processing TBᵢⱼ.

Advantageously, elementary processing TBᵢⱼ comprises the step of combining COMB data from data sub-block SBᵢⱼ, to generate an elementary image IEᵢⱼ.

Elementary processing TBᵢⱼ elementary advantageously comprises the steps listed below, implemented by computer:
Combining COMB data from the data sub-block SBᵢⱼ, to generate an elementary image IEᵢⱼ,
Enhancing AM the signals from the microbubbles, to generate an enhanced elementary image IAᵢⱼ from the elementary image IEᵢⱼ,
Detecting DE microbubbles on the enhanced elementary image IAᵢᵢ to obtain a set of positions Pᵢⱼₘ of microbubbles MIᵢⱼₘ detected on the enhanced elementary image IAᵢᵢ,
Locating LO the detected microbubbles so as to generate a set of sub-pixel or sub-voxel positions of microbubbles PSiⱼₘ with m=1 to M with M integer greater than or equal to 0.

The elementary processing steps TBᵢⱼ for a given i are implemented in the temporal order defined by the acquisition orders j of the elementary data sub-blocks SBᵢⱼ or in another temporal order

The combination step COMB is used to switch from time space to distance space. The elementary image is, for example, two- or three-dimensional.

By elementary image IEᵢⱼ, we mean a mesh of pixels or voxels whose respective intensities are representative of acoustic properties of the medium surrounding the probe in respective coordinates. The coordinates of a pixel or voxel represent a position relative to the probe of a point in the surrounding environment.

Block processing TBᵢ of data block Bᵢ of order i then comprises a step of time tracking SU of microbubbles MIᵢⱼₘ on the different enhanced elementary images IAᵢⱼ (with j=1=J) generated for data block Bᵢ or on at least a part, i.e. on at least a plurality these enhanced elementary images, so as to obtain sets of positions of contrast agents, e.g. microbubbles. For example, assuming that microbubbles are tracked on all IAᵢⱼ enhanced elementary images (with j=1=J) and that no microbubbles disappear, we obtain J positions PSᵢⱼₘ for each of the M microbubbles Miₘ detected.

Note that the LO localization step is optional. The tracking step can consist in tracking the positions Pᵢⱼₘ of the microbubbles obtained during the detection step DE, instead of tracking the more precise positions PSᵢⱼₘ obtained during the localization step LO

The block processing step TBᵢ may then comprise a step of RE reconstruction of an image from data generated during TBᵢ block processing of the i-th order Bᵢ data block.

For example, the reconstruction step RE comprises a step of reconstructing an image IRᵢ representing the paths followed by different microbubbles on the different enhanced elementary images AMᵢⱼ generated from the respective data sub-blocks SBᵢⱼ of the i-order data blocks Bᵢ, i.e. representing the positions Pᵢⱼₘ or PSᵢⱼₘ of the microbubbles followed on the respective data sub-blocks SBᵢⱼ. The processing step T may then comprise a step of global reconstruction REG of a global image IG from data generated during i-order block processing TBᵢ of the i-order data block Bᵢ, for example, from images IRᵢ reconstructed during reconstruction steps RE, for example from images IRᵢ with i=1 to N.

In other words, the global reconstruction step REG of a global image IG is performed from a plurality of images IRᵢ generated for different i or for all i from 1 to N.

The images IRᵢ and any global image IG are super-resolution images when the method includes the localization step LO.

The steps listed above are carried out by conventional methods known to the skilled person, which will not be described again here. Non-limiting examples of the methods used are given below.

The step of combining COMB data from the data sub-block SBᵢⱼ to generate an elementary image IEᵢⱼ advantageously comprises combining data from at least one elementary data set RFᵢⱼₕₖ acquired for index i and index j of the data sub-block SBᵢⱼ.

The combination step COMB of data of the data sub-block SBᵢⱼ to generate an elementary image IEᵢⱼ, advantageously comprises combining data from a plurality of elementary data sets RFᵢⱼₕₖ acquired for index i and index j of the data sub-block SBᵢⱼ.

The COMB step of combining data from the data sub-block SBᵢⱼ to generate an elementary image IEᵢⱼ advantageously comprises combining data from each elementary data set RFᵢⱼₕₖ acquired for index i and index j of the data sub-block SBᵢⱼ.

The combination step COMB includes, for example, a beamforming step.

In one embodiment, the lane formation step is performed using the Delay & Sum method.

For example, in the case of 2D plane-wave imaging, there is a single sub-aperture defined by transducers aligned along a probe axis. The individual beams Wₖ are plane waves emitted at respective angles αₖ to a normal direction. Elementary images IEᵢⱼ are obtained by combining signals acquired by transducers delayed by τ(x, x′, αₖ) delays:

$${IE}_{ij} ( z , x ) = {\sum }_{{α}_{k} , x ′} {RF}_{ij {α}_{k}} ( τ ( x , {x}^{′} , {α}_{k} ) )$$

$$Where τ ( x , {x}^{′} , {α}_{k} ) = \frac{z cos {α}_{k} + x sin {α}_{k}}{c} + \frac{\sqrt{{z}^{2} + {( x - {x}^{′} )}^{2}}}{c}$$

Where x is a coordinate of a point along the probe axis in a probe-related frame of reference; z is a coordinate of a point along the normal to the probe axis in the probe-related frame of reference and x′ is a transducer coordinate along the probe axis in the probe-related frame of reference.

The sum is performed on the x′ coordinates of the various transducers and on the respective angles αₖ with k=1 to K.

The sum is performed only on the x′ coordinates in the case of a single angle α.

In the case of a plurality of transmission/reception configurations,. Elementary images IEᵢⱼ are obtained by combining signals acquired by transducers delayed by τ(x, x′, αₖ) delays as follows:

$${IE}_{ij} ( z , x ) = {\sum }_{{α}_{k} , {x}^{′} , h} {RF}_{ijh {α}_{k}} ( τ ( x , {x}^{′} , {α}_{k} ) )$$

The sum is performed on the x′ coordinates of the different transducers, on the respective α₍ₖ) angles and on the different transmission/reception configurations with h=1 to H.

The combination step COMB can be carried out by other methods known to the skilled person based on mathematical models, for example, by path training in Fourier space, using adaptive or multivariate methods. Alternatively, it can be performed by a learning method using, for example, a neural network trained to reconstruct elementary images from sub-block data.

In a particular embodiment, the elementary acquisition step seₕ comprises the implementation of a plurality of individual acquisition sequences siₕₖ with k=1 to K and K is an integer greater than 1. These individual acquisition sequences siₕₖ differ in that the spatial and/or temporal characteristics of the beams emitted during their respective emission steps Eₕₖ differ as previously explained.

The combination step COMB implemented during elementary processing TBᵢⱼ comprises, for example, a plurality of channel-forming steps, the respective channel-forming steps use data acquired under the effect of respective beam emission, during acquisition of the data sub-block SBᵢⱼ, so as to form a plurality of intermediate images and a combination step, e.g. averaging of these intermediate images so as to form the elementary image. This method is known as “compounding” or “coherent compounding”. It increases image contrast and resolution. Combining a plurality of images reduces noise and therefore increases contrast. Combining images acquired with separate beams increases resolution.

Alternatively, K is equal to 1.

Alternatively and/or additionally, the step sbⱼ for acquiring a sub-block SBᵢⱼ comprises the implementation of a plurality of elementary acquisition sequences seₕ, where h=1 to H and H is an integer greater than 1. These elementary acquisition sequences seₕ differ in the transmission/reception configurations used Cₕ. This type of method enables probes with a larger number of transducers to be addressed than the number of electronic processing channels available

In this case, the combination step COMB advantageously includes a known step of concatenating the data acquired with the different transmission/reception configurations so as to recompose the entire field of view. This step is carried out prior to the channel formation step(s).

The combination step includes, for example, a concatenation step for the data acquired by means of the various elementary sequences.

Alternatively, H=1.

The enhancement step AM implemented to improve the signals of the elementary image IEᵢⱼ, which originate from the microbubbles with respect to other signals of the elementary image IEᵢⱼ can use only the IEᵢⱼ elementary image or this image and at least one of the other IE_{(ij)(′)} elementary images with j′ different from j. In other words, this step improves the contrast between these two types of signals.

In a particular embodiment, the enhancement step AM of the elementary image IEᵢⱼ is implemented using all the images generated for the jth order sub-block of the ith order block. This enhancement step AM consists, for example, in enhancing the signals from the microbubbles compared with those from the surrounding tissue, for example, the walls of the blood vessels in which the microbubbles circulate.

The enhancement step AM includes, for example, a filtering step to remove tissue signals from the elementary image and retain only microbubble signals. This step is known, for example, as “clutter filtering” or fouillis filtering. It includes, for example, the application space-time filters of the Singular Value Decomposition (SVD) type to separate echoes from microbubbles from echoes from tissue.

Alternatively, the enhancement step AM uses a non-linear strategy. This involves, for example, a particular processing method based on the emission of specific beams during the acquisition stage. The beam is, for example, defined so as to perform a phase inversion known as “Pulse Inversion”, an amplitude modulation, for example amplitude modulation on long sets (AMLE), a CHIRP emission, emission using a Golay code, or other equivalent strategies

The above methods use the elementary image IEᵢⱼ, and at least one other elementary image generated for another sub-block of the ith-order block to enhance the IEᵢⱼ elementary image.

For example, these methods use all the elementary images generated for order block i to implement the elementary image IEᵢⱼ enhancement step i.e. all the images IEᵢⱼ generated for index i and for j=1 to J.

The microbubble detection step DE is carried out, for example, by searching for local maxima in the intensity of pixels or voxels in the enhanced image. This step typically enables microbubbles to be positioned to the nearest pixel or voxel.

The microbubble localization step LO consists in improving the accuracy of the microbubble positions obtained in the detection step DE. This is advantageously a localization method with sub-pixel or sub-voxel precision.

The localization step LO is, for example, performed by weighted averaging of the intensity of neighboring pixels/voxels, by interpolation, for example using a Gaussian, Cubic, Spline, or Lanczos kernel, by fitting a Gaussian function better known as a “Gaussian fit”, by an algorithm using the radial symmetry of the signal from an isolated microbubble, or more generally from an isolated contrast agent, and which explicitly calculates the position as the point minimizing the distance to the current lines of the spatial gradient, or any other equivalent method. Interpolation and Gaussian fitting methods are accurate. Weighted-average methods are accurate.

The microbubble tracking step SU is implemented, for example, using the nearest neighbor method, which consists in assigning to each microbubble of the sub-block SBᵢⱼ, the microbubble of the sub-block SBᵢⱼ₊₁ whose distance is closest; or by using the Kuhn Munkres algorithm, also known as the Hungarian method, which consists in minimizing the sum of the distances between all the microbubbles in sub-block (i,j) and all the microbubbles in sub-block (i,j+1). It is also possible to combine these approaches with Kalman filters to incorporate a priori assumptions into these tracking methods.

Block processing TBᵢ can, of course, include further steps.

It can, for example, include a microbubble position correction step that can be carried out in parallel with other steps in the block processing step TBᵢ and comprises a step for estimating displacements (e.g. due to patient breathing) and a correction step using these displacements to correct elementary images or enhanced images or directly microbubble positions calculated during the location step.

Block processing can include a step for correcting various aberrations due to ultrasound propagation through biological tissues, such as the skull or a layer of fat. These corrections can, for example, use microbubbles to determine a general law of aberration and use this to correct delays during the combination COMB.

The method can include a step for processing microbubble trajectories to correct spatial and temporal sampling artifacts.

The reconstruction steps RE and REG, for example, are performed by accumulation.

For example, the space is meshed into voxels of predefined size, and the value of each voxel is incremented each time a contrast agent, e.g. a microbubble, is detected in this voxel during the block treatment TBᵢ follow-up stages or during the first treatment TBᵢ follow-up stages with i=1 to N. This creates a representation of the blood volume in the field of observation. For each voxel, it is also possible to represent the average velocity of the microbubbles that have passed through it.

Alternatively, the elementary processing TBᵢⱼ comprises some of the steps shown in FIG. 5, e.g. the combination step COMB and possibly the enhancement step and/or the detection step and/or the localization step LO and/or the tracking step SU and/or the reconstruction step RE.

Advantageously, the processing of block TBᵢ of order i comprises, for example, instead of the detection, localization and tracking steps, following the implementation of the enhancement step AM for each of the sub-blocks so as to enhanced images IAᵢⱼ for j=1 to J, an image reconstruction step, based on the enhanced images IAᵢⱼ generated for the order i block (i.e. for j=1 to J), using a stochastic optical fluctuation imaging method known as SOFI. The result is an improved resolution of root 2 compared with the resolution of the enhanced images.

Alternatively, an ultrasensitive Doppler imaging method is known, in which the reconstruction step RE consists in temporally averaging the enhanced images obtained for the different data sub-blocks SBᵢⱼ (with j=1 to J) generated for a given i.

Alternatively, following implementation of the enhancement step AM for each of the sub-blocks, so as to obtain enhanced images IAᵢⱼ, the method includes a texture tracking step, more commonly known as Speckle Tracking, so as to obtain a sequence of images.

Alternatively, the block processing step TBᵢ includes the combination step COMB to obtain the IEᵢⱼ images. The reconstruction step RE is implemented by averaging all or part of the images IEᵢⱼ obtained for the different SBᵢⱼ sub-blocks, so as to obtain an image better known as a B-mode image.

### Acquisition and Processing System

FIG. 6 shows a block diagram of the system SYS according to one embodiment of the invention, configured to implement the method according to the invention.

The SYS system includes, for example, an acquisition system SA and a processing system, which is a processing device DT in the non-limiting example shown in FIG. 6.

Alternatively, the processing system comprises different elements capable of communicating by wired or wireless means.

The acquisition system SA comprises a probe S and an acquisition device DA.

The probe S comprises the array R of transducers TR.

The transducer TR array can be one-dimensional. The transducers TR are then arranged in a line. The line is, for example, a straight line, in which case the array is linear, or curved. Alternatively, as in the example shown in FIG. 6, the transducers TR are arranged in rows and columns on a flat or curved surface. Advantageously, the transducers TR are evenly distributed in space. In one variant, the transducers TR are distributed randomly in space to form a parsimonious probe. Another variant is to use probes called RCAs for Raw-Column Arrays, where the elements of the same row and column are connected to each other.

The acquisition device DA comprises a transmitter EM, a controller CTR, a possible multiplexer MUX, a pre-processing module MPR comprising a analog-to-digital converter CAN, a first memory MT and a probe communication system CO1.

The acquisition system DA is configured to implement acquisition step A of the method according to the invention.

The multiplexer MUX selectively addresses the transmit and reception sub-apertures.

When excited by the transmitter EM, via the multiplexer MUX, each transducer TR transmits an ultrasound pulse.

The controller CTR is able to control the other elements of the acquisition device DA.

The controller CTR is configured to control, at each transmission step Eₕₖ:
the transmitter EM such that it generates a defined excitation for the TR transducers, so that the transmission sub-aperture SOo, receiving the excitation, transmits an ultrasound beam Wₖ defined by its temporal and spatial properties,
the multiplexer MUX such that the excitation is transmitted to the transducers of the transmission sub-aperture SOo.

For example, the transmitter EM generates an excitation signal defining a waveform and a predetermined frequency of the wave and applies different delays to this signal so as to generate respective elementary excitation signals intended to excite the respective transducers TR of the transmission sub-aperture SOo so as to define a direction of the Wₖ beam intended to be emitted by the sub-aperture SOo.

The controller CTR controls the switch configuration of the multiplexer MUX so that the multiplexer transmits the respective excitation element signals to the respective transducers TR of the transmission sub-aperture SOo so that the array of transducers TR transmits the Wₖ emission beam

The controller CTR is configured to control, at each reception step Rₕₖ, the multiplexer MUX so that only the transducers TR of the reception sub-aperture SOo′ transmit the electrical signals generated as a result of the emission of the W₍ₖ) ultrasound beam to the pre-processing device MPR.

The pre-processing device MPR may also include, for example, at least one filter and/or demodulator and/or time-gain compensator and/or sampler.

The controller CTR is programmed to control elements of the acquisition device DA so that the latter implements the acquisition step A.

In one embodiment, the controller CTR comprises, for example, a set of at least one processor operationally coupled to a memory in which is stored a program executed by the controller CTR for the acquisition system DA to implement acquisition step A.

The multiplexer MUX transmits the signals received by the transducers TR of the reception sub-aperture SOo′ to the pre-processing device MPR comprising the analog-to-digital converter CAN to generate digital raw data sets RFᵢⱼₕₖ from the echo signals. These data sets are stored in the memory MT of the acquisition device ACQ in the storage step MEMₕₖ.

Advantageously, the first memory MT is a RAM memory. It is, for example, a buffer memory of the acquisition device DA.

The acquisition device DA comprises a set of at least one communication system CO1 enabling the acquisition device DA to communicate with the probe S and with a set of at least one communication system CO2 of the processing device DT so as to enable the transmission of data from the memory MT of the acquisition device ACQ to the processing device DT, for example to a second memory MDT of the processing device DT.

The controller CTR is able to control the communication system C1 of the acquisition device DA so that it transmits the data to the communication system CO2 of the processing device DT.

The processing system, for example the processing device DT, comprises the second memory MDT, a processing unit UT and a man-machine interface INT comprising an input interface INTE and an output interface INTS.

Advantageously, as shown in FIG. 4, prior to the block processing step TBᵢ, the method includes a transfer step TRAᵢ of the data block Bᵢ to the second memory MDT. This has the advantage of emptying the first memory MT and enabling the acquisition method to continue without saturating the first MT memory. In the particular example shown in FIG. 4, processing of block TBᵢ of order i begins when the transfer step TRAᵢ of data block Bᵢ of order i has been completed. Alternatively, the block processing step TBᵢ of order i starts during the transfer step TRAᵢ of order i. In other words, the transfer step is performed at least in part prior to the block processing step TBᵢ. block processing TBᵢ can begin as soon as a sub-block has been transferred from the first memory MT to the second memory MDT.

The transfer step TRAᵢ is, for example, performed by the communication system CO1 under the control of the controller CTR.

The transfer step TRAᵢ is, for example, implemented during the Aᵢ₊ₖ₀ acquisition of i+k0 order Bᵢ₊ₖ₀ data block, during which the block processing step TBᵢ of the i order data block Bᵢ is implemented or started

In the particular example shown in FIG. 1, k0=1. The smaller k0 is, the smaller the size of the first memory MT can be.

This applies to at least one i, for example to all i less than or equal to N−k0.

Advantageously, during the transfer step TRAᵢ, the B₍ᵢ) data block is erased from the first MT memory. transfer of data TRAᵢ from the first memory MT to the second memory MDT enables data acquired during the acquisition of the B₍ᵢ₊ₖ₎₍₀₎ data block to be stored in the first memory MT.

Advantageously, the second memory MDT is a RAM memory of the processing device DT. One advantage is the speed of storage.

Advantageously, the data block Bᵢ is transmitted directly from the first memory to the second memory MDT without passing through another memory.

In a particular embodiment, the second memory MDT is a GPU memory.

The processing unit UT is configured to implement the processing step T or at least the block processing step TBᵢ of the method according to the invention.

In one embodiment, the processing unit UT comprises, for example, a set of at least one processor operatively coupled to a memory in which is stored a program executed by the processing unit UT for the processing unit UT to implement the processing step T.

The processing unit UT and/or the controller CTR are configured to synchronize the operations performed by the acquisition system SA and the processing system so as to implement the method according to the invention.

The data generated during block processing TBᵢ is stored in the second memory MDT.

This data can then be transferred to an internal memory of the processing system DT, for example the processing device DT.

Advantageously, this data is transferred after acquisition step A. Advantageously, these data are transferred after the processing step. T

Advantageously, the elementary image(s) EIᵢⱼ generated during block processing and/or the enhanced image(s) IAᵢⱼ generated during block processing as well as the positions Pᵢⱼₘ, any enhanced positions PSᵢⱼₘ, any sequence of positions of the various microbubbles and any image IRᵢ generated during block processing TBᵢ are stored simultaneously in the second memory MDT.

This enables the data generated during the corresponding block processing to be stored in the second memory. This enables calculations to be made using data generated during different sub-block processes of the block process, such as enhancement using different elementary images generated during the block process, tracking or reconstruction.

Alternatively, the improved positions PSᵢⱼₘ replace the positions Pᵢⱼₘ in the second memory MDT.

In another variant compatible with the previous one, the position sequences replace the enhanced positions in the second MDT memory.

In a further variant compatible with the preceding variants, the positions Pᵢⱼₘ and/or any enhanced positions PSi₍ₘ and/or any sequence of positions of the various microbubbles generated during block processing replace the elementary image(s) IEᵢⱼ generated during block processing and/or the enhanced image(s) IAᵢⱼ generated during block processing

Replacing the images with the positions in the second memory significantly reduces the amount of memory occupied and the time required to transfer the data stored in the second memory to another memory.

In one embodiment, when one or more enhanced images IAᵢⱼ are generated during block processing TBᵢ, they replace the elementary image(s) IEᵢⱼ generated during block processing TB₍ᵢ₎.

Alternatively, each elementary image IEᵢⱼ and each enhanced image IAᵢⱼ generated during block processing TBᵢ are stored simultaneously in the second memory MDT.

Advantageously, this applies to the data generated during each block processing TBᵢ carried out in processing step T.

Thus, at the end of processing step T, the second memory MDT stores the data generated during each block processing or the data which, among the data generated during each block processing, is retained in the second memory MDT at the end of each block processing TBᵢ.

The data remaining in the second memory MDT can then be transferred to an internal memory of the processing system, for example the processing device DT.

The transfer of these data is advantageously carried out after the acquisition step A.

Advantageously, these data are transferred after the T processing step.

Alternatively, the data is stored directly in an internal memory of the processing device.

Advantageously, the processing device DT or processing system is configured to implement the AFFᵢ display step, and the processing unit UT is configured to generate the data to be displayed during this step.

This step consists of displaying a representation of information from data generated during the block processing step TBᵢ. It can be implemented at the end of the block processing step TBᵢ, as in the example shown in FIG. 5, or at any other time during the block processing step, once data has been generated.

This involves, for example, displaying one of the images IEᵢⱼ, IAᵢⱼ, of an image IRᵢ constructed from positions Pᵢⱼₘ generated from one or more data sub-blocks, or a table of values for these positions, an indicator or a score.

If the data displayed is not data obtained during the steps COMB, AM, DE, LO, SU, the block processing step TBᵢ advantageously comprises a step for calculating data to be displayed from data calculated during one of these steps in order to display the data to be displayed during the display step. Advantageously, each block processing step TBᵢ comprises the display step AFFᵢ.

Alternatively, at least one block processing TBᵢ comprises the display step AFFᵢ.

When the elementary processing TBᵢⱼ comprises only some of the steps COMB, AM, DE, LO, SU shown in FIG. 5, the processing unit UT is advantageously configured to control the transmission, via the system CO2, to a second processing unit of the processing system, for example, another processing device or a server, of data generated during block processing TBᵢ. The second processing unit is advantageously configured to implement the remaining steps taken from COMB, AM, DE, LO, SU or at least one of these steps.

The RE reconstruction step can be implemented by the processing unit UT or a second processing unit. In the latter case, the processing unit UT is advantageously configured to control transmission, via the system CO2, to the second processing unit of the processing system.

Advantageously, the elementary processing steps TBᵢⱼ implemented, for j=1 to J, during a block processing step Tᵢ, are implemented in parallel, i.e. simultaneously. This enables fast processing of the SBᵢⱼ data sub-blocks. In other words, the data block Bᵢ can be processed quickly.

Alternatively, the elementary processing steps TBᵢⱼ are carried out in parallel for a plurality of sub-blocks taken from the sub-blocks of the order i block.

The system, in particular the memories and processing unit(s), and the communication systems are configured, in particular sized, to enable the method according to the invention to be implemented. This configuration is, for example, carried out experimentally.

### Hardware

From a hardware point of view, the processing system and the controller CTR can be seen as computers interacting with computer programs.

The processing system DT and acquisition device DA comprise at least one computer, for example, a microcomputer, a computer network, an electronic component, a tablet, a smartphone or a personal digital assistant (PDA).

The data processing unit UT, any second processing unit, and the controller CTR each comprise, for example, a computer, comprising a set of at least one processor, and possibly a memory operationally coupled to the computer

The memory comprises, for example, a computer-readable medium. The computer-readable medium is a tangible device readable by a reader of the processing unit, capable of storing electronic instructions and of being coupled to the communication system CO1, CO2.

In other words, the computer-readable medium is a tangible medium. In other words, it is not a transient signal per se, such as radio waves or other freely propagating electromagnetic waves, such as light pulses or electronic signals. Such a computer-readable storage medium is, for example, an electronic storage device, a magnetic storage device, an optical storage device, an electromagnetic storage device, a semi-conductor storage device or any combination thereof.

Examples of readable media include optical disks, magneto-optical disks, read-only memories (ROMs), erasable programmable read-only memories (EPROMs), Electrically Erasable Programmable Read-Only Memory (EEPROM), Random Access Memory (RAM), magnetic card or optical card ().

Each of the first memory MT and the second memory MDT can be of one of the above types.

The readable medium can include an operating system and load programs according to the invention. It includes registers adapted to record parameter variables created and modified during the execution of the aforementioned programs. A computer program containing software instructions is then stored on the readable medium.

Alternatively, program instructions are taken from an external source and downloaded via a network. This is particularly the case for applications.

The data processing unit UT, any second processing unit and the controller CTR each comprise a computer, i.e. at least one electronic data processing circuit designed to manipulate and/or transform data represented by electronic or physical quantities in evaluation system registers and/or memories into other similar data corresponding to physical data in the register memories or other types of display devices, transmission devices or storage devices.

The data processing unit UT and/or any second processing unit and/or controller CTR comprise, for example, memories, for storing data, operatively coupled to the data processing circuit and a reader adapted to read a computer-readable medium.

The steps of the method according to the invention are, for example, performed by causing the processing circuits of the data processing unit UT, the possible second processing unit, and the controller CTR to read predetermined programs stored on hardware such memories so that their data processing circuits perform calculations, control communications and read and/or write data to memories.

The processing step is, for example, carried out on a processing device, such as a single computer, or on a distributed system between a plurality of computers (in particular via the use of cloud computing).

The data processing unit UT, any second processing unit, and the controller CTR each comprise at least one computer comprising at least the elements listed below: a set of one or more processors (e.g. at least one central processing unit (CPU) and/or at least one graphics processing unit (GPU) and/or at least one microcontroller and/or at least one digital signal processor (DSP)) capable of interpreting instructions in the form of a computer program and/or a hardware element, such as an electronic board, in which steps of the method according to the invention are implemented in hardware elements.

In a particular embodiment of the invention, the processing unit UT comprises a GPU graphics processor. Alternatively, the processing unit comprises a central processing unit (CPU).

The invention relates to a computer program product comprising the computer-readable medium containing instructions which, when executed by the processing circuit, cause the system S to implement the steps of the method according to the invention, i.e. to execute the functional bricks of the system according to the invention.

The program product may include a computer-readable recording medium.

Alternatively, the program instructions are taken from an external source and downloaded via a network. This is particularly the case for applications. In this case, the computer program product comprises a computer-readable data carrier on which the program instructions are stored, or a data carrier signal on which the program instructions are encoded.

The form of the program instructions is, for example, a source code form, a computer-executable form or any intermediate form between a source code and a computer-executable form, such as the form resulting from conversion of the source code via an interpreter, assembler, compiler, linker or localizer. Alternatively, the program instructions are microcode, firmware instructions, state definition data, configuration data for integrated circuit (e.g. VHDL) or object code. Program instructions are written in any combination of one or more programming languages, e.g. an object-oriented programming language (C++, JAVA, Python), a procedural programming language (e.g. C language).

The communication systems CO1, CO2 enable communication between system elements and possibly between at least one system element and a device external to the system. The communication systems can establish a physical link between elements of the system and/or between an element of the system and a device external to the system and/or a remote (wireless) communication link between elements of the system and/or between an element of the system and a device external to the system.

The communication systems can comprise any hardware, firmware and/or software suitable for communicating information between elements of the device to which the communication system belongs, for example via a data bus, or to an element external to the device. In order to enable data communication between different devices to which the communication systems belong, these systems comprise firmware and/or software hardware enabling a wired, or wireless, communication link to be established between them, for example Wi-Fi, Bluetooth, cellular or Ethernet.

The user interface INT enables a user to enter data or commands so as to be able to interact with the programs according to the invention.

The user interface INT includes, for example, an output interface INTS and an input interface INTE.

The input interface includes, for example, a keyboard or a pointing interface, such as a mouse, an optical pen, a touchpad, a remote control, a voice recognition device or a haptic device.

The output interface INTS is designed to output information to a user, either sensorially or electrically, such as visually or acoustically. The output interface comprises, for example, a display. The display step AFFᵢ can then be a step of restitution of information from data generated during order i block processing by the output interface INTS, by means other than a display.

The output interface INTS can be the input device INTE, for example, in the case of a touchscreen tablet.

The invention also relates to a computer program product comprising instructions which lead the system according to the invention to carry out the steps of the method according to the invention, as well as to a computer-readable medium on which the computer program is recorded.

### Special Material Realization

In a particular embodiment of the invention, the DA acquisition device comprises a housing enclosing and/or supporting the DA acquisition device elements shown in FIG. 6. The DA acquisition device forms an object intended to be wired to the S probe.

In the particular embodiment shown in FIG. 6, the processing system is a processing device DT, for example a microcomputer, designed to be connected in wired or wireless communication, for example via a Wifi network, to the acquisition device DA.

Alternatively, the acquisition device DA is integrated into the processing device DT.

In a particular embodiment, the processing device DT is a microcomputer, for example, a portable or human-portable computer.

For example, it can be mounted on wheels so that a human can move it easily.

Alternatively, the processing system comprises a first processing device comprising the second memory MDT and the processing unit. The processing system comprises an output device comprising the interface INT or the output interface INTS connected in communication, for example wireless or wired, with the processing device, via the communication system CO2. The output device is, for example, a telephone or a tablet. Alternatively, the processing unit UT is distributed between the first processing device and the output device so that the output device performs part of the block processing.

1. A method for acquiring and processing ultrasound waves comprising:
a sequential acquisition of N elementary data blocks (Bᵢ) of order i, with i=1 to N, and
the computer-implemented sequential processing (T), by computer, the elementary data blocks (Bᵢ), the order i of each raw elementary data block (Bᵢ) being an acquisition order number of the elementary data block (Bᵢ) among the N data blocks,
the sequential acquisition (A) comprising, for each elementary data block, an acquisition (Aᵢ) of the elementary data block (Bᵢ) of order i comprising J implementations of a data sub-block acquisition of order j (SBᵢⱼ), for j=1 to J with J greater than 1, the sub-block acquisition comprising, for each transmission/reception configuration (Cₕ) of a set of at least one transmission/reception configuration (Cₕ) defined by a transmission sub-aperture (SOo) and a reception sub-aperture (SOo′) of an array (R) of transducers (TR), a set of at least one individual acquisition sequence (siᵢⱼₕₖ) comprising:
transmitting (Eₕₖ) an ultrasound beam (Wₖ), through the transmission sub-aperture (SOo), into an area of interest on a patient,
receiving (Rₕₖ), by the reception sub-aperture (SOo′), echoes generated by the zone of interest under the effect of the ultrasound beam, to generate electrical signals,
pre-processing (PTₕₖ) comprising digitizing of signals from the electrical signals to generate an elementary data set (RFₕₖⱼᵢ)
the sequential processing (T) comprising, for at least one of the elementary data blocks (Bᵢ) of order i, a computer-implemented block processing (TBᵢ) of order i, comprising, for at least one data sub-block (SBᵢⱼ) of order j, an elementary processing (TBᵢⱼ) comprising combining (COMB) data of the data sub-block (SBᵢⱼ) of order i to generate an elementary image-(IEᵢᵢ),
the block processing (TBᵢ) of order i being implemented during the acquisition (Aᵢ₊ₖ₀) of order i+k0 with k0 being an integer greater than 0, i+k0 being less than or equal to N.

2. The method according to claim 1, wherein J is between 2 and 2000.

3. The method according to claim 2, wherein N is between 2 and 10000.

4. The method according to claim 1, wherein the block processing (TBᵢ) of order i is implemented during the acquisition (Aᵢ₊₁) of the data block (Bᵢ₊₁) of order i+1.

5. The method according to claim 1, wherein the block processing (TBᵢ) of order i is implemented only during acquisition (Aᵢ₊ₖ₀) of the data block (Bᵢ₊ₖ₀) of order i+k0.

6. The method according to claim 1, comprising, during acquisition (Aᵢ₊ₖ₀) of the data block of order i+k0, providing a user, via a user interface, information from data generated during the block (TBᵢ) processing of order i.

7. The method according to claim 1, wherein the elementary processing (TBᵢⱼ) comprises enhancing (AM) signals from contrast agents on the elementary image (IEᵢⱼ) relative to other signals to obtain an enhanced elementary image (IAᵢⱼ).

8. The method according to claim 7, wherein the block processing (TBᵢ) of order i, comprises, for each of a plurality data sub-blocks (SBᵢⱼ) of order j, an elementary processing (TBᵢⱼ) comprising combining (COMB) data of the data sub-block (SBᵢⱼ) of order i, to generate a plurality of elementary images (IEᵢⱼ), enhancing (AM) the elementary image (IEⱼᵢ) of order j using the elementary image (IEᵢⱼ) of order j and at least one other elementary image generated for another data sub-block.

9. The method according to claim 1, wherein the elementary processing (TBᵢⱼ) comprises detecting signals from contrast agents on the elementary image or on an image from the elementary image (IEᵢⱼ) to obtain a set of positions of contrast agents (PSᵢⱼₘ).

10. The method according to claim 1, wherein the block processing (TBᵢ) of order i comprises, for each of a plurality of data sub-blocks (SBᵢⱼ) of order j (SBᵢⱼ), the elementary processing (TBᵢⱼ) comprising combining (COMB) data of the data sub-block (SBᵢⱼ) of order j, to generate a plurality of elementary images (IEᵢⱼ), the block processing (TBᵢ) comprising tracking (SU) contrast agents on a plurality of elementary images or images from elementary images to obtain sets of positions of contrast agents.

11. The method according to claim 10, wherein the block processing (TBᵢ) of order i comprises a step of reconstructing (RE) an image (IRᵢ) representing the sets of positions of the contrast agents.

12. The method according to claim 11, wherein sequentially processing (T) comprises carrying out the block processing (TBᵢ) for a plurality of blocks to generate a plurality of images (IRᵢ), sequentially processing (T) comprising globally reconstructing (REG) a global image (IG) from a plurality of images (IRᵢ) generated during the sequentially processing.

13. The method according to claim 1, wherein the block processing (TBᵢ) of order i comprises elementary processes (TBᵢⱼ) implemented for respective data sub-blocks, in parallel.

14. The method according to claim 1, wherein the individual acquisition sequence (siᵢⱼₕₖ) comprises storing the elementary data set in a first memory (MT), the method comprising transferring the elementary data block of order i to a second memory (MDT), implemented, at least in part, prior to block processing (TBᵢ).

15. The method according to claim 14, wherein the first memory (MT) and the second memory (MIDT) are random access memories, the elementary data block being transmitted from the first memory (MT) to the second memory (MDT) without passing through another memory.

16. An ultrasound waves acquisition and processing system configured to implement the method according to claim 1, the acquisition and processing system comprising:
an acquisition system (SA) comprising the array (R) of transducers (TR) and configured to implement the acquisition step (A),
a processing system (DT) configured to implement the sequential processing step (T).

17. A system according to claim 16 configured to implement the method according to claim 14, wherein the acquisition system (SA) comprises the first memory (MT) and the processing system (DT) is intended to be communicatively connected to the acquisition system (SA), the processing system comprising the second memory (MDT).

18. A computer program product comprising instructions that causes the system of claim 16 to perform the steps of the method.

19. A computer-readable medium comprising on which the computer program according to claim 18 is recorded.
